(19) United States
(12) Patent Application Publication
(10) Pub. No.: US 2011/0212755 A1
(43) Pub. Date: Sep. 1, 2011

(54) MOBILE TERMINAL DEVICE

(75) Inventors: Takehisa ISHIKAWA, Kawasaki (JP); Tatsuhito ARAKI, Kawasaki (JP); Hiroaki SAKASHITA, Kawasaki (JP); Hiroaki MATSUDA, Kawasaki (JP); Hidehiko HIZUKA, Kawasaki (JP); Takashi SUZUKI, Kawasaki (JP); Kouki MURAKAMI, Kawasaki (JP)

(73) Assignee: FUJITSU LIMITED, Kawasaki-shi (JP)

(21) Appl. No.: 12/874,209

(22) Filed: Sep. 1, 2010

(30) Foreign Application Priority Data
Sep. 2, 2009 (JP) 2009-203042

(51) Int. Cl. H04W 88/02

(52) U.S. Cl. 455/575.1

(57) ABSTRACT

A mobile terminal device includes a housing formed with an opening, a base plate provided inside the housing and having an audio component attached thereon, a cushion part provided around the opening of an inside wall surface of the housing, a frame part that includes a face near a surface of the audio component and forms an audio path between the audio component and the opening, one end portion near the face of the frame part being attached to the base plate, and another end portion abutting the inside wall surface of the housing via the cushion part.

### CROSS-REFERENCE TO RELATED APPLICATIONS

This application is based upon and claims the benefit of priority of the prior Japanese Patent Application No. 2009-203042, filed on Sep. 2, 2009, the entire contents of which are incorporated herein by reference.

### FIELD

The present invention relates to a mobile terminal device.

### BACKGROUND

Mobile terminal devices such as mobile telephones with voice functions are equipped with audio components such as microphones and speakers. The audio components are provided inside a housing of the mobile terminal device. The audio components pick up sound outside of the housing and emit sounds to the outside of the housing through an opening that is made in the housing. For example, a microphone converts sounds that enter the housing through the opening in the housing of the mobile terminal device to electrical signals. The mobile terminal device can obtain good quality sound by substantially sealing the space between the opening and the audio components and by substantially preventing the diffusion of sound inside the housing. Various configurations with high sealing performance in and around audio components in mobile terminal devices have been studied and have been used.

For example, a cushion made up of an elastic material such as rubber or foamable resin is inserted between adjacent components and the microphone in the mobile terminal device, thereby improving the performance in sealing the space between the microphone and the opening provided in the housing. FIG. 7 illustrates an example of sealing the space around the microphone due to cushioning.

As illustrated in FIG. 7, a microphone 20 is attached to a base plate 10 and picks up sounds entering through an opening 60a that is made in the housing 60. An internal frame 30 is provided to seal the space between the microphone 20 and the opening 60a. Cushions 40a and 40b are inserted between the internal frame 30 and the microphone 20. Cushions 70a and 70b are inserted between the internal frame 30 and the housing 60. Cushions 40a and 40b and cushions 70a and 70b include foamable resin for example. The cushions 40a and 40b and the cushions 70a and 70b deform a certain degree in response to pressure between the microphone 20 and the internal frame 30, and between the internal frame 30 and the housing 60, thus improving the performance in sealing the spaces between the microphone 20 and the opening 60a.

Cushions are not inserted directly between the microphone 20 and the housing 60. The internal frame 30 is provided to split the cushioning into two parts so that the thickness of each of the cushions is small, which assures stability between components. In the example illustrated in FIG. 7, a spacer 50 is placed next to the microphone 20 and the cushion 40a is inserted in between the internal frame 30 and the microphone 20 with the spacer 50, because the shape of the microphone 20 is asymmetrical. Accordingly, the cushion 40a is prevented from dropping off the microphone 20 and stability between components is improved.

See also Japanese Laid-open Patent Publication No. 2007-96843.

However, since cushions are inserted to absorb tolerance variations by deforming with pressure from adjacent components, misalignment in audio component areas increases when cushion insertion locations are increased. As a result, the following problems occur. The sealing performance around audio components decreases and audio characteristics deteriorate. If the number of cushions to be inserted increases, the number of components also increases. Furthermore, operating man-hours for the assembly of mobile terminal devices also increases.

To address these problems, the gap between the base plate and the housing may be decreased to bring the microphone closer to the opening, and cushioning may be inserted directly between the microphone and the housing. However, for example, mobile telephones have many functions besides audio functions and thus have many components to respond to those functions. Thus it is difficult to adjust the position of the base plate only to address the audio characteristics. Since mobile terminal devices are provided with display and camera parts for example, the position of the base plate needs to be adjusted in consideration of interference between components and the sizes of components. Therefore, the gap between the microphone and the opening becomes larger, the thicknesses of the cushions inserted between the microphone and the housing become larger, and cushion installation stability may not be achieved.

### SUMMARY

According to an aspect of the invention, a mobile terminal device includes a housing formed with an opening, a base plate provided inside the housing and having an audio component attached thereon, a cushion part provided around the opening of an inside wall surface of the housing, a frame part that that includes a face near a surface of the audio component and forms an audio path between the audio component and the opening, one end portion near the face of the frame part being attached to the base plate, and another end portion abutting the inside wall surface of the housing via the cushion part.

The object and advantages of the invention will be realized and attained by means of the elements, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a perspective view of a front side of a mobile terminal device according to an embodiment.

FIG. 2 is a perspective view of a back face side of a mobile terminal device according to an embodiment.

FIG. 3 is a schematic view of a cross-section along line I-I of FIG. 2.

FIG. 4 is an enlargement of a cross-section along line II-II of FIG. 2.

FIGS. 5A to 5C are assembly drawings illustrating a configuration around a microphone from the front side according to the first embodiment.

FIGS. 6A to 6C are assembly drawings illustrating a configuration around a microphone from the back face side according to the first embodiment.

FIG. 7 is a cross-section illustrating an example of a configuration around a microphone.

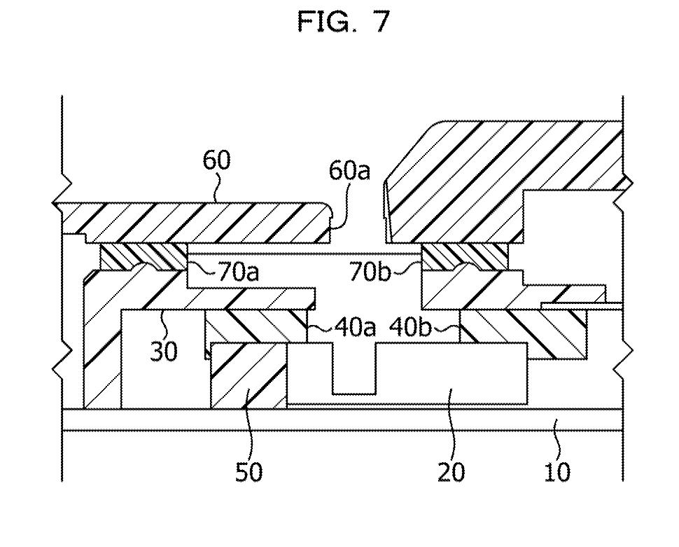

### DESCRIPTION OF EMBODIMENTS

The embodiments of the present invention will herein be described in detail with reference to the attached drawings. A mobile telephone will be used as an example of a mobile terminal device to explain the following aspects of the embodiment. However, the present invention is not limited to this embodiment.

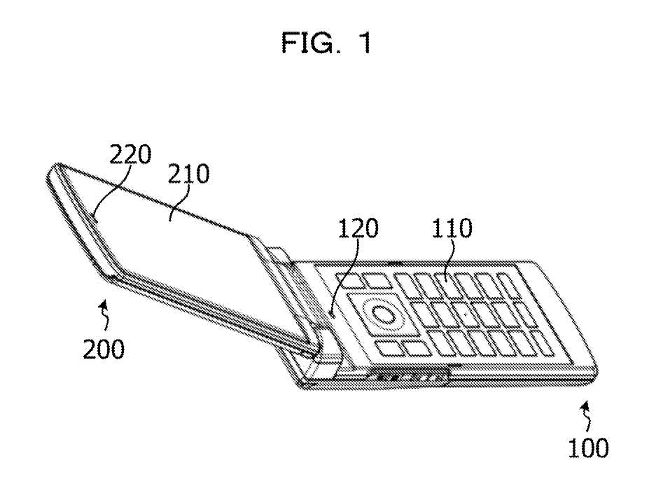

FIG. 1 is a perspective view of a front side of the mobile terminal device according to the embodiment. As illustrated in FIG. 1, the mobile terminal device according to the present embodiment is a foldable mobile telephone that includes a fixed housing 100 and a movable housing 200. The fixed housing 100 includes an operating key section 110 and an opening 120. The movable housing 200 is rotatably attached to the fixed housing 100, and includes a display 210 and an opening 220. The face that includes the operating key section 110 and the display 210 as illustrated in FIG. 1 is the face that a user approaches for talking, and will be called a “front face.” The rear face of the face that includes the operating key section 110 and the display 210 will be called a “back face.”

The operating key section 110 receives input operations from the user. For example, the operating key section 110 may receive telephone number input operations and start or finish talking input operations.

The opening 120 is a through hole to a microphone provided inside the fixed housing 100 at the front side. Sounds emitted by the user enter the fixed housing 100 from the opening 120 and are picked up by the microphone located at the front side. The mobile terminal device of the present embodiment uses a double microphone construction. One microphone each is located at the front side and the back face side. By using the double microphone construction, nearby background noise may be reduced, for example, while talking.

The display 210 displays various types of information and may include a liquid crystal panel, for example. The display 210 may display a telephone number input using the operating key section 110, for example.

The opening 220 is a through hole for a receiver located inside the movable housing 200. The receiver that emits a received voice is included inside the movable housing 200, and the voice emitted by the receiver may be heard from the opening 220.

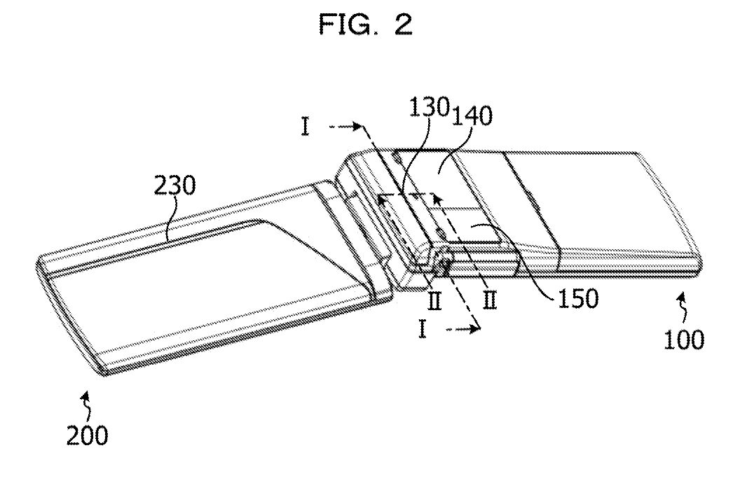

FIG. 2 is a perspective view of a back face side of the mobile terminal device according to the embodiment. As illustrated in FIG. 2, an opening 130, a fingerprint sensor section 140, and a camera section 150 are located on the back face of the fixed housing 100. An illumination section 230 is located on the back face of the movable housing 200.

The opening 130 is a through hole toward a microphone provided inside the fixed housing 100 at the back face side. Sounds emitted by the user enter the fixed housing 100 from the opening 130 as well as the above-described opening 120 and are picked up by the microphone on the back face side. The internal structure in the vicinity of the opening 130 in the fixed housing 100 will be described below.

The fingerprint sensor section 140 includes a fingerprint sensor for user authorization. The fingerprint sensor section 140 reads the fingerprints of the user to identify the user and allow or disallow use of the mobile terminal device. Since the fingerprint sensor included in the fingerprint sensor section 140 is attached to the base plate of the back face side of the fixed housing 100 like the microphone, the gap between the fixed housing 100 and a base plate is adjusted according to the thickness of the fingerprint sensor. The gap between the back face side microphone and the opening 130 is greater than the gap between the opening 120 and the front face side microphone.

The camera section 150 includes a camera for imaging. The camera in the camera section 150 is a relatively large component and so the thickness of the fixed housing 100 is defined by the thickness of the camera. The thickness of the fixed housing 100 may not be less than the thickness of the camera included in the camera section 150.

The illumination section 230 illuminates by emitting light from, for example, a light emitting diode (LED). The illumination section 230 may be illuminated as a color or a specific pattern to inform the user that a call has been received.

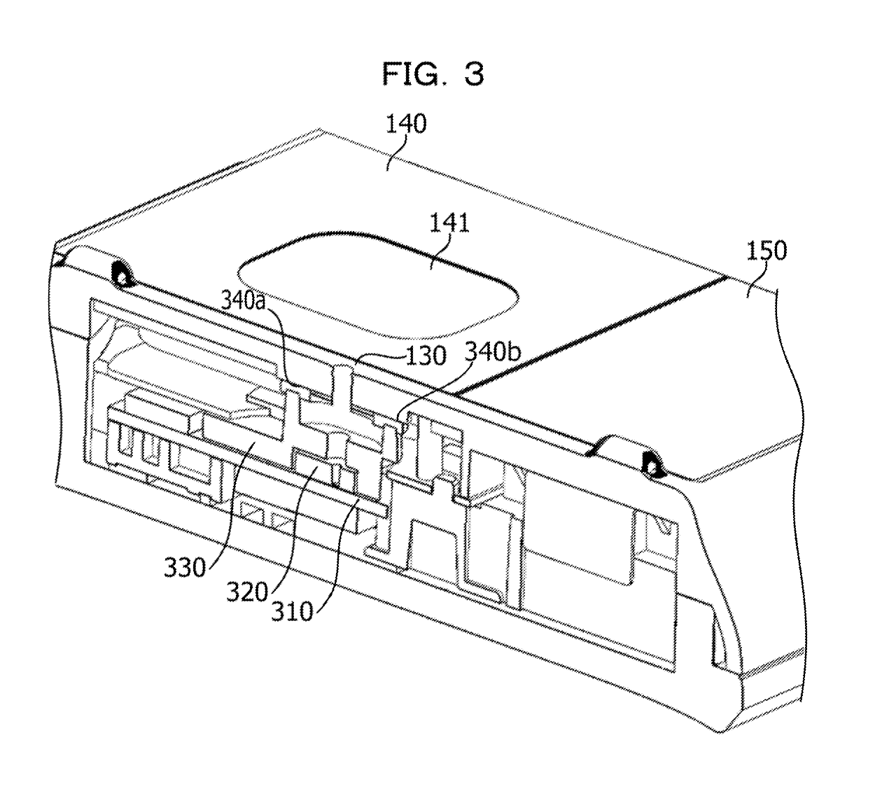

FIG. 3 is a schematic view of a cross-section along line I-I of FIG. 2. FIG. 3 illustrates a cross-section of the fixed housing 100 at the line I-I which passes through the opening 130. The cross-section illustrates a base plate 310, a microphone 320, an internal frame 330, and cushions 340a and 340b.

The base plate 310 is positioned according to the thickness of a fingerprint sensor 141 included in the fingerprint sensor section 140. The distance between the base plate 310 and the back face of the fixed housing 100 is larger than the distance between the base plate 310 and the front face of the fixed housing 100.

The microphone 320 is provided on the back face side of the base plate 310 and picks up sound entering the fixed housing 100 through the opening 130. The microphone 320 picks up the sound that is conveyed through the space sealed by the cushions 340a and 340b and the internal frame 330. Thus, the audio characteristics of the microphone 320 may be desirably maintained.

The internal frame 330 is attached to the base plate 310 with double-sided tape, for example, and forms a compartment that seals and contains the area around the microphone 320 between the internal frame 330 and the base plate 310. Also, the internal frame 330 forms an audio section in the vicinity of the opening 130. Sounds entering the fixed housing 100 echo moderately in the audio section. A through hole is formed in the internal frame 330 to guide sound that enters the audio section into the compartment so that the sound that enters the fixed housing 100 reaches a sound perception section of the microphone 320. The internal frame 330 forms a sound path between the opening 130 and the microphone 320. A construction of the internal frame 330 will be described below.

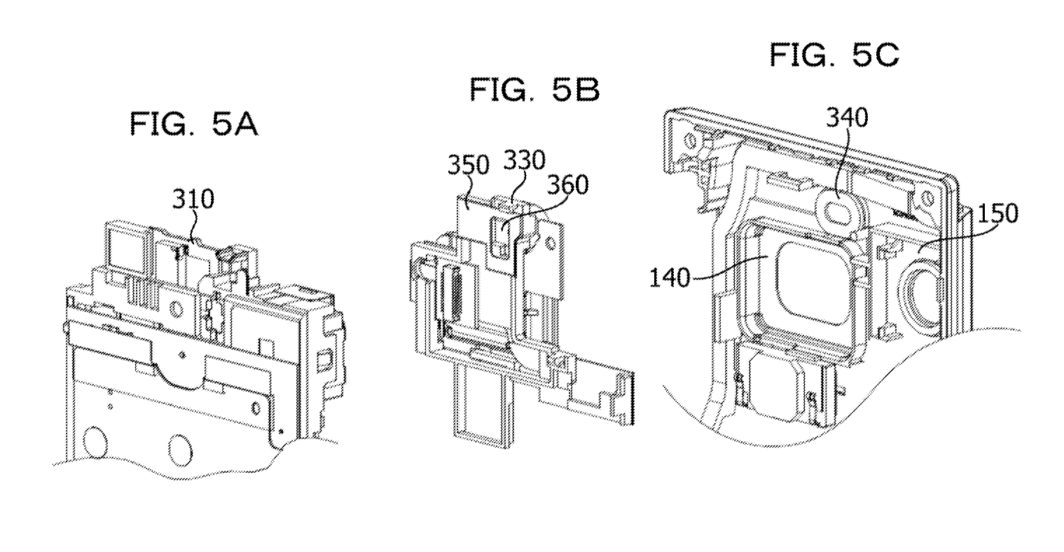

Cushions 340a and 340b are inserted between the internal frame 330 and an inside wall surface of the fixed housing 100. By sealing the audio section formed by the internal frame 330 with the cushions 340a and 340b, the sound that enters the fixed housing 100 from the opening 130 is substantially prevented from diffusing. The cushions 340a and 340b may include elastic material such as foamable resin, for example. The cushions 340a and 340b deform in response to pressure between the inside wall surface of the fixed housing 100 and the periphery that encompasses the audio section of the internal frame 330, and seal the gap between the internal frame 330 and the fixed housing 100. Two cushions 340a and 340b are illustrated in FIG. 3. However, in actuality, FIG. 3 illustrates the cross-section of two locations of one cushion 340, which is more clearly illustrated in FIG. 5C. As illustrated in FIG. 5C, cushion 340 is placed to encircle the opening 130.

In the present embodiment, the area around the microphone 320 is directly sealed by the compartment of the internal frame 330 attached to the base plate 310, and the cushions 340a and 340b are inserted between the inside wall surface of the fixed housing 100 and the internal frame 330. Too much cushioning that impairs the stability between components may be overcome with one cushion, and additional components to ensure stability, such as spacers, may be unnecessary. In the present embodiment, manufacturing man-hours and the number of components may be reduced and stability may be maintained by providing cushioning. In the present embodiment, sealing performance around the microphone 320 may be achieved and the deterioration of audio characteristics may be substantially prevented.

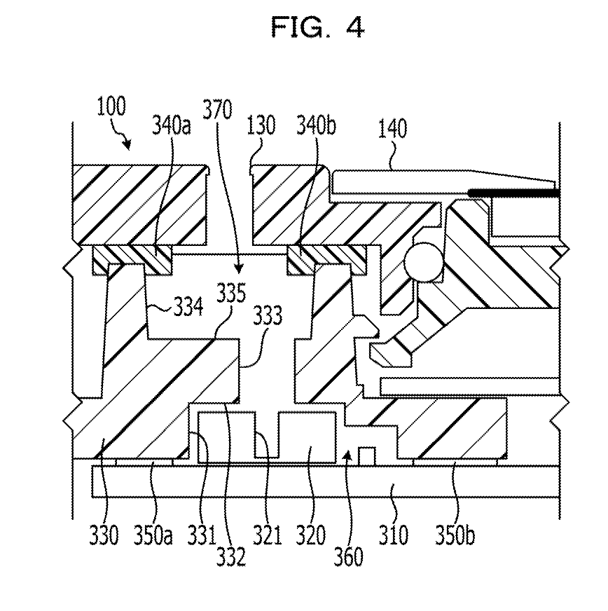

The construction around the microphone 320 of the present embodiment will be described in reference to FIG. 4. FIG. 4 is an enlargement of a cross-section along line II-II of FIG. 2. As illustrated in FIG. 4, the microphone 320 that includes a sound perception section 321 is provided on the base plate 310. One end portion of the internal frame 330 that surrounds the microphone 320 is attached to the base plate 310 with double-sided tape 350a and 350b. Since the base plate 310 and the internal frame 330 are attached by the double-sided tape 350a and 350b, the base plate 310 and the internal frame 330 are sealed together so that sounds are not diffused around the microphone 320 in the present embodiment. Shifting of the positions of the base plate 310 and the internal frame 330 does not occur in the present embodiment. Thus, stability between components may be maintained in the present embodiment.

Since the other end portion of the internal frame 330 abuts the inside wall surface of the fixed housing 100 via the cushions 340a and 340b, the internal frame 330 is sealed against the inside wall surface of the fixed housing 100 and the sound that enters the fixed housing 100 through the opening 130 is not diffused. The sound that enters the fixed housing 100 through the opening 130 does not leak outside the space formed by the inside wall surface of the fixed housing 100, the cushions 340a and 340b, the internal frame 330, the double-sided tape 350a and 350b, and the base plate 310. Thus, the audio characteristics of the microphone 320 may be improved in the present embodiment.

Details of the shape of the internal frame 330 will be described. In the area around the microphone 320, a face 331 and a face 332 of the internal frame 330 abut a side face and a top face of the microphone 320 respectively to form a compartment 360. The compartment 360 has a shape that covers the area around the microphone 320 and substantially prevents sound from diffusing in the area around the microphone 320.

Near the opening 130 of the fixed housing 100, an air chamber is formed with a face 334 and a bottom face 335 and spreads around the opening 130. This air chamber acts as an audio section 370. Sounds that enter the fixed housing 100 through the opening 130 echo moderately in the audio section 370 to improve the audio characteristics. A through hole 333 that is provided in the bottom face 335 of the audio section 370 opens onto the compartment 360.

In the compartment 360, the through hole 333 opens up near a sound perception section 321 of the microphone 320, and sounds that enter the audio section 370 are guided toward the sound perception section 321. Since the faces 331 and 332 that form the compartment 360 are near the microphone 320, the diffusion of sound guided by the through hole 333 is minimized in the area around the sound perception section 321 in the present embodiment. The microphone 320 may accurately pick up sounds entering the fixed housing 100 through the opening 130. In the present embodiment, the microphone 320 is used as an example of an audio component in the description, and so the through hole 333 opens near the sound perception section 321. However, if, for example, a speaker is provided as an audio component, the through hole 333 may open near a sound emission section of the speaker.

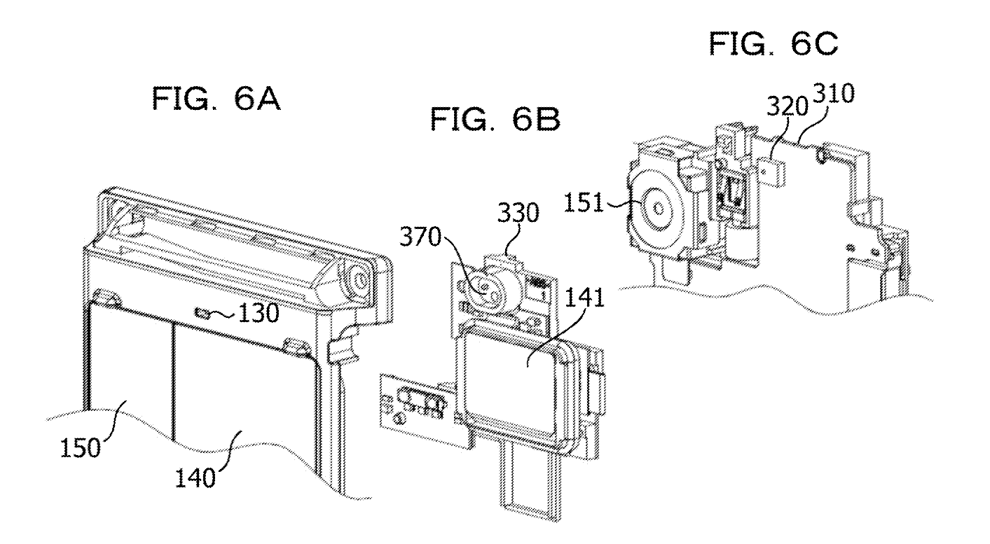

An internal configuration of the mobile terminal device according to the present embodiment will be described by referring to FIGS. 5A to 5C and FIGS. 6A to 6C. FIGS. 5A to 5C are assembly drawings illustrating a configuration around a microphone from the front side according to the first embodiment. FIGS. 6A to 6C are assembly drawings illustrating a configuration around a microphone from the back face side according to the first embodiment.

The internal frame 330 is sandwiched between the base plate 310 near the front side illustrated in FIG. 5A and FIG. 6C, and a housing case including the fingerprint sensor section 140 and the camera section 150 illustrated in FIG. 5C and FIG. 6A. The fingerprint sensor 141 illustrated in FIG. 6B is integrated with the internal frame 330 illustrated in FIGS. 5B and 6B. The camera 151 illustrated in FIG. 6C is integrated with the base plate 310. The fingerprint sensor 141 faces the fingerprint sensor section 140 of the housing case. The camera 151 faces the camera section 150 of the housing case.

Double-sided tape 350 illustrated in FIG. 5B is attached to the surface of the internal frame 330 facing the base plate 310. The internal frame 330 is attached to the base plate 310 using the double-sided tape 350. The internal frame 330 tightly abuts the base plate 310 with the compartment 360 which is formed, as illustrated in FIG. 5B, in roughly the same shape as the microphone 320 attached to the base plate 310. In the present embodiment, diffusion of sound around the area of the microphone 320 may be substantially prevented.

As illustrated in FIG. 5C, the oval-shaped cushion 340 is provided at the inside wall surface of the housing case in a location that encircles the opening 130. The cushion 340 is attached to the inside wall surface of the housing case by double-sided tape, for example. The oval shape of the cushion 340 corresponds to the shape of the audio section 370 of the internal frame 330. The performance in sealing the audio section 370 is assured by the cushion 340. A side wall that includes the face 334 of the audio section 370 (see FIG. 4) has an oval cylinder shape. The cushion 340 is provided to seal the periphery of the bottom face of the oval cylinder shape. Since the side wall of the audio section 370 abuts the cushion 340, no gaps exist in the audio section 370, except the opening 130 and the through hole 333 provided in the bottom face 335 of the audio section 370. Thus, in the present embodiment, diffusion of sound that enters through the opening 130 is substantially prevented.

According to the present embodiment, a space in roughly the same shape as a microphone is formed by a base plate which holds the microphone and an internal frame attached to the base plate by double-sided tape. The microphone is provided in the space and cushioning is provided between the internal frame and a fixed housing. In the present embodiment, sound that enters the fixed housing through an opening provided in the fixed housing may be guided toward the microphone without allowing diffusion in the area around the microphone. In the present embodiment, the use of cushioning to assure sealing performance is minimized and the shifting of components is substantially prevented. Thus, in the present embodiment, stability between components around the microphone may be maintained and deterioration of audio characteristics may be substantially prevented.

The above embodiment refers to a folding mobile telephone; however the above embodiment is not limited to a foldable mobile telephone. The present embodiment may be applicable to a sliding type of mobile devices in which a movable housing slides in relation to a fixed housing, or a straight type in which the housing is not split.

The above embodiment describes a sealed configuration around a microphone; however the configuration may also be applied in a similar way in between a speaker and an opening in a housing. A similar configuration may be used in various other mobile terminal devices including audio functions such as an integrated circuit (IC) recorder instead of a mobile telephone.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A mobile terminal device, comprising:
a housing formed with an opening;
a base plate provided inside the housing and having an audio component attached thereon;
a cushion part provided around the opening of an inside wall surface of the housing; and
a frame part that includes a face near a surface of the audio component and forms an audio path between the audio component and the opening, one end portion near the face of the frame part being attached to the base plate, and another end portion abutting the inside wall surface of the housing via the cushion part.

2. The mobile terminal device according to claim 1, wherein the frame part is attached to the base plate with double-sided adhesive tape.

3. The mobile terminal device according to claim 1, wherein the cushion part is attached to the inside wall surface of the housing with double-sided adhesive tape.

4. The mobile terminal device according to claim 1, wherein the frame part includes:
an audio section that forms an air chamber around the opening by abutting the inside wall surface of the housing via the cushion part, and
a compartment that is connected to the audio section through a through hole formed in a bottom face of the audio section, and encloses the audio component by attaching the one end portion near the face of the frame part to the base plate.

5. The mobile terminal device according to claim 4, wherein the compartment seals an area around the audio component except for the through hole that opens near a sound perception part provided in the audio component.

6. The mobile terminal device according to claim 1, wherein the cushion part includes foamable resin that deforms under pressure.

7. A method for assembling a mobile terminal device, the method comprising:
providing a housing with an opening;
attaching a base plate, having an audio component, inside the housing;
attaching a cushion part around the opening of an inside wall surface of the housing; and
providing a frame part that includes a face near a surface of the audio component and forms an audio path between the audio component and the opening, one end portion near the face of the frame part being attached to the base plate, and another end portion abutting the inside wall surface of the housing via the cushion part.

8. The method of assembling the mobile terminal device according to claim 7, wherein the frame part is attached to the base plate with double-sided adhesive tape.

9. The method of assembling the mobile terminal device according to claim 7, wherein the cushion part is attached to the inside wall surface of the housing with double-sided adhesive tape.

10. The method of assembling the mobile terminal device according to claim 7, wherein the frame part includes:
an audio section that forms an air chamber around the opening by abutting the inside wall surface of the housing via the cushion part, and
a compartment that is connected to the audio section through a through hole formed in a bottom face of the audio section, and encloses the audio component by attaching the one end portion near the face of the frame part to the base plate.

11. The method of assembling the mobile terminal device according to claim 10, wherein the compartment seals an area around the audio component except for the through hole that opens near a sound perception part provided in the audio component.

12. The method of assembling the mobile terminal device according to claim 7, wherein the cushion part includes foamable resin that deforms under pressure.
